(19) United States
(12) Patent Application Publication
(10) Pub. No.: US 2010/0294137 A1
(43) Pub. Date: Nov. 25, 2010

(54) BAKING DEVICE FOR TYPES OF FATTY FOODS BAKED IN FAT BATHS, IN PARTICULAR FOR HOUSEHOLDS

(76) Inventors: Istvan Janosi, Budapast (HU); Peter Roman, Budapest (HU); Laszlo Vogronics, Erd (HU)

Correspondence Address: Hershkovitz & Associates, LLC, 2845 Duke Street, Alexandria, VA, 22314, US

(21) Appl. No.: 12/863,592

(22) PCT Filed: Jan. 19, 2009
(86) PCT No.: PCT/HU2009/000005

§ 371 Date: Jul. 19, 2010

(30) Foreign Application Priority Data
Jan. 25, 2008 (HU) P0800048

(51) Int. Cl. A47J 37/12

(52) U.S. Cl. 99/403

(57) ABSTRACT

The object of the invention is a baking device for types of fatty foods that are baked in fat baths, in particular for households, in which baking device a fat pan (10) is located which can be placed on attachments (13) fastened to the housing of the baking device and removed therefrom, and in which a heating unit (8) is located between the base plate of the baking device and the fat pan (10), a lower baking plate (20) and an upper baking plate (27) being further located in said baking device, said plates being fastened together to form an enclosed baking unit, removable from one another, and at least the mutually parallel surfaces thereof being perforated or formed in a network fashion. The essence of the invention is that the baking device comprises a lower housing (2) and an upper housing (3), the upper housing (3) being provided with a cover (6) that can close the upper edge thereof, said upper housing able to be connected to the lower housing (2) with an air-tight and water-tight fit and able to be removed therefrom, the fat pan (10) being further located in the lower housing (2), the baking unit being located in the upper housing (3), and the baking unit being located between the support column (14), which is parallel with the middle line of the baking unit, and the guide strut (29) where the baking unit can be lowered in a known fashion without rotation and can be raised with a rotation of 180° .

The subject-matter of the invention is a frying appliance for making deep-fried pastries, in particular for households, in which there is—an oil pan arranged on spacers fixed to and removable from the cover of the frying appliance, and

a heating element between the bottom of the frying appliance and the oil pan, and

a lower frying plate and an upper frying plate—perforated at least on their parallel surfaces or grill-like in design—which can be spaced from each other and when fixed together compose a single frying unit.

It is a known fact that saucepans are used even nowadays for making deep-fried pastries particularly doughnuts widely common and popular all over the world and the wide variety of popular Hungarian specialties including “lángos” (“langosh”). Cooking oil is poured in the pan or frying is done using fat so that previously prepared and portioned raw pastry in a size-dependent quantity is put into the pan to fry them on one side and then turned over with a fork to fry the other side.

However, there is much room for improving such process from a hygienic point of view. Grease can splash particularly when melting or when turning the pastry during frying or lifting the fried pastry from the pan to cause, in better cases, spots around the frying area which can be cleaned or, in worse cases, burn wounds if splashed on the person preparing the food.

It is a known fact that special appliances and automatic machines are widely used for making deep-fried pastries which, albeit free from the deficiencies mentioned above, are uncommon in households where such types of pastries are made less frequently.

Such automatic machine is described by patent description No. HU P0700005. The raw pastry is fed through an opening on the automatic unit's cover by horizontally rotating the pastry placed on the frying plate. Prior to frying, the frying plate is clamped with a perforated frying plate cover to make a closed frying unit for the time of frying. The frying unit is immersed in the frying grease to allow the pastry to float on the grease inside the frying unit. After frying the bottom side, the frying unit is lifted by the drive unit and then rotated around its midline and lowered back into frying grease to fry the other side of the pastry. Having completed frying, the drive mechanism lifts the frying unit again and rotates it 2×90degrees to drain the surplus grease, removes the frying plate cover to open the frying unit and finally laterally rotates the frying plate together with the pastry through the opening in the cover of the automatic unit. The next portion can by fried by removing the fried pastry from the frying plate.

Owing to the fact that the apparatus is lockable from a thermal point of view, the automatic unit is dust-free, energy saving and environmentally friendly, and due to its compact design it requires little space, however, it requires additional space during feeding and emptying due to the horizontal rotation of the frying plate, on the one hand, and that its considerable use can only be expected in the middle-class population and, therefore, it will probably only become widespread in a relatively narrow circle for reasons of economy, on the other hand.

The objective of the invention is to make an appliance for the deep-frying of pastries including, particularly, pastries of larger size, e.g. langosh, which offers the advantages of the automatic unit mentioned above (dust-free, energy saving, environmentally friendly and compact) and is at the same time capable of becoming popular due to its simple and economic design.

The invention is based on the recognition that the frying unit can be configured without rotation if the raw dough is fed and the fried pastry is removed manually in the traditional manner, and the frying unit is configured by clamping the frying plate and the frying plate cover, constituting the frying unit, along their edges using a swivel-pin and by closing and opening the frying plate cover.

The substance of the invention is that

the cover comprises a lower cover and an upper cover, where

the upper cover possesses a lid opening along the upper edge of the lower cover and the cover an airtight and leak-proof fit with which it is joined to the lower cover so that it can be fixed and released, and

the oil pan is located in the lower cover while the frying unit is located in the upper cover, and

the frying unit is arranged between the support column and the guiding column, being parallel with the midline of the frying unit, in the known manner, where the frying unit can be lowered without rotation and raised by turning it 180 degrees.

The invention is described in detail using the embodiments shown in the figures,

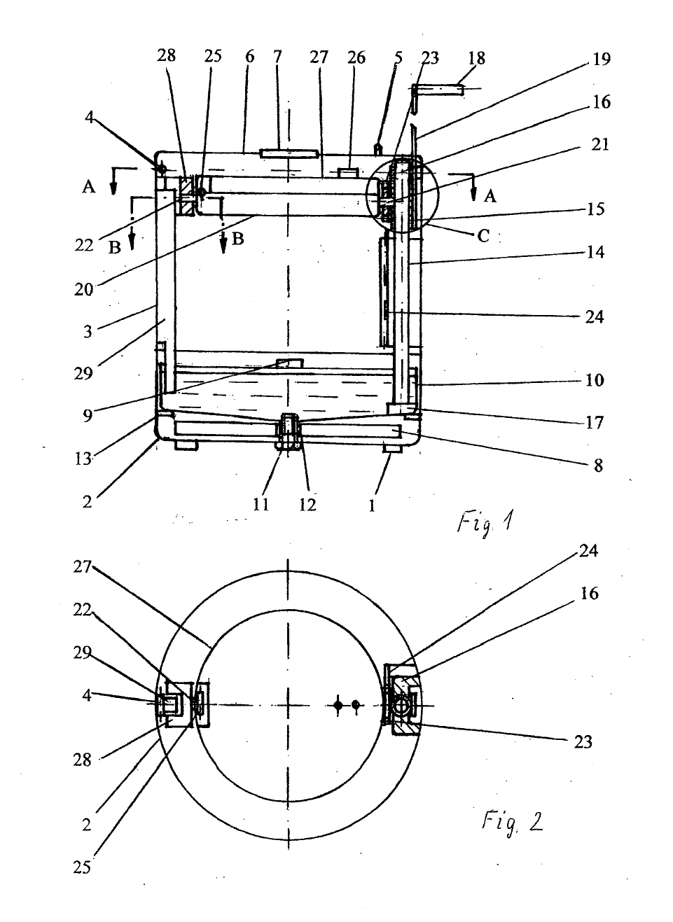

FIG. 1 shows the longitudinal section of the vertical midline of an embodiment of the frying appliance described in the invention, and

FIG. 2 is the A-A sectional view of the frying unit according to FIG. 1,

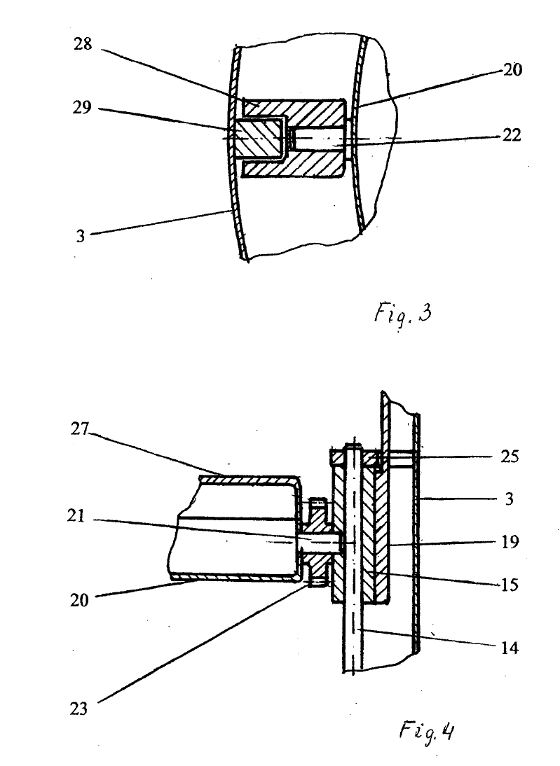

FIG. 3 is section C, and

FIG. 4 is the B-B section thereof.

The frying appliance shown in the embodiments in FIGS. 1 and 2 is arranged with a heat insulated and preferably cylindrical lower cover 2 and upper cover 3 standing on feet 1 The diameters of the external surfaces of the covers 2 and 3 are preferably identical and the lower edge of the surface of the upper cover 3 is connected to the upper edge of the surface of the lower cover 2 in the known manner, i.e., using an airtight and leak proof fitting which can be fixed and released. There is a lid 6, fitted with a handle 5, which opens when rotated around the swivel-pin 4, fixed to the upper edge of the upper cover 3. The lid 6 is fitted with a removable filter cartridge 7 on its surface and preferably in the environment of the vertical midline of the appliance.

There is a heating element 8 above the cover's 2 bottom-plate and the oil pan 10, fitted with lifting tabs 9 allowing removal from the cover 2, is located above the heating element 8. When ready for frying, the upper edge of the oil pan 10 is under the level of the upper edge of the cover 2. The bottom-plate of the oil pan 10 is preferably fitted with an oil drain opening 12 which is lockable with a screw 11, passes through the bottom-plate of the cover 2 and the heating element 8 and is situated in the vertical midline of the cover 2. The oil pan 10 rests on the cover 2 with the spacers 13 fixed to the cover 2.

There is a support column 14, parallel with the vertical midline of the cover 2, extending into the oil pan 10 in the environment of the surface of the cover 2, and a sliding support tube 15 is mounted on the support column 14. The upper end of the support column 14 is U-shaped and attached to the surface of the cover 3 with the upper column support 16, while the lower end of the support column 14 is arranged in a manner that it can be slid into the hole of the lower column support 17 fixed to the bottom of the oil pan 10. There is a vertical moving arm 19, preferably fitted with a handle 18 at its top end, fixed to the surface of the support tube 15 on its side facing the cover 3.

There is a hole on the surface of the support tube 15 extending into and with its axis perpendicular to the vertical midline of the cover 3, into which a pin 21, fixed at a 180 degree angle, penetrates in a diameter perpendicular on the vertical midline of the cover 3 towards the lower frying plate 20 being perpendicular to the vertical midline of the cover 3. (FIG. 3) There is another pin 22, coaxial with the pin 21, fixed to the lower frying plate 20 on the opposite side of the diameter of the lower frying plate 20. (FIG. 4) There is a gear 23, fitted with a ratchet mechanism, fixed to the pin 21 between the support tube 15 and the frying plate 20, and is in a functional connection with the rack 24 fixed to the surface of the cover 3 and parallel with the component of the cover 3.

There is an upper frying plate 27, fitted with a handle 26, fixed to the upper edge of the lower frying plate 20, where the upper frying plate opens when rotated around the swivel-pin 25. When closed, the frying plates 20 and 27 are locked together by a known latch, e.g. shutter. The frying plates 20 and 27 or at least the plates of the frying plates 20 and 27 parallel with each other are perforated or fitted with grills so the frying plates 20 and 27 make a closed frying unit during frying so that the hot frying oil is drained through the perforations or grill.

The pin 22 of the lower frying plate 20 is located so as to extend into the U-shaped and preferably rectangular cross section swivel inhibitor 28 so that it can rotate therein. The arms of the swivel inhibitor 28 unit are arranged so that they extend along and are guided by the opposite sides of the preferably rectangular cross section guiding column 29, fixed to the surface of the cover 3. The lower reduced cross-section end of the guiding column 29 extends into the oil pan beyond the lower edge of the cover 3.

The frying appliance described in the invention is operated as follows:

After filling the oil pan 10, the upper cover 3 is placed in the lower cover 2 and, if necessary, clamped together in the already known manner. The heating is switched on and the oil is heated to a temperature of around 180° C. With the upper frying plate 27 is open, the previously prepared and formed raw dough is placed on the lower frying plate 20 (one large piece or as many smaller ones that fit). The size of smaller raw pastries should be large enough to prevent it from turning inside the frying unit, i.e., not to fry the same side twice. The upper frying plate 27 is folded onto the lower frying plate 20 and the lid 6 is locked onto the cover 3, and the frying unit is ready for frying.

By pressing the moving arm 19 down, the gear with a ratchet mechanism 23 passes along the rack 24 so that the two do not lock in the meantime and thus the frying unit moving downwards does not turn. When the frying unit is at its end-position, the grease entering through the lower frying plate 20 fills up the frying unit up approximately halfway so that the pieces of dough float on the surface of the oil. The frying appliance may be fitted with light and/or sound signals in the usual manner, which is activated by the frying unit when it reaches its lower end-position. The signal will turn on at the end of the predetermined frying time and will operate until the frying unit is lifted or the signal is turned off.

After the predetermined or necessary frying time is up, the gear with a ratchet mechanism 23 locks with the rack 24 when the moving arm 19 is pulled upwards, and rotates the frying unit 180 degrees so that the fried side faces upwards and the side to be fried downwards. The length and position of the rack 24 must be set so that the frying unit must not immerse in the oil in any position during rotation and that it must not knock into against the lid 6 at the end of rotation.

Then, the other side is fried in the same manner as the first side with the difference that after the frying is completed it needs to briefly stop while moving upwards when the frying unit is in the vertical position after a 90-degree rotation in order to allow the excess oil to drip from the ready fried pastry back into the oil pan. After opening the lid 6 and the upper frying plate 27, the fried pastry can be removed from the apparatus and the next frying can be started by placing another batch of raw pastry into the unit.

1. Frying appliance for making deep-fried pastries, particularly for households with
a frying pan resting on spacers fixed to the cover of the frying unit and removable from there, and
a heating element between the bottom of the frying appliance and the oil pan, and
a lower frying plate and an upper frying plate—perforated at least on their parallel surfaces or grill-like in design—which can be spaced from each other and when fixed together compose a single frying unit,
characterized in that
the cover comprises a lower cover (2) and an upper cover (3),
the upper cover (3) possesses a lid (6) opening along the upper edge of the lower cover (2) and the lid has an airtight and leak-proof fit with which it is joined to the lower cover so that it can be fixed and released, and
the oil pan (10) is located in the lower cover (2) while the frying unit is located in the upper cover (3), and
the frying unit is arranged between the support column (14) and the guiding column (29), being parallel with the midline of the frying unit, in the known manner, where the frying unit can be lowered without rotation and raised by turning it 180 degrees.

2. The frying appliance described in claim 1 wherein:
there is a sliding support tube (15) on the support column (14), and
the support column (14) is attached to the inner surface of the upper cover (3) with the upper column support (16) fixed to its ends and to the bottom of the oil pan (10) with the lower column support (17).

3. The frying appliance described in claim 2 wherein:
there is a vertical moving arm (19), preferably fitted with a handle (18) at its top end, fixed to the surface of the support tube (15) on its side facing the cover (3).

4. The frying appliance described in claim 2 wherein:
there is a pin (21) fixed to the lower frying plate (20) extending into the hole going through and with an axis perpendicular to the vertical midline of the upper cover (3), on the surface of the support tube (15),
and a gear with a ratchet mechanism (23), is fixed on the pin (21) between the support tube (15) and the lower frying plate (20), and
the gear (23) is in a functional connection with the rack (24), fixed to the surface of the upper cover (3) and parallel with the component of the surface of the upper cover (3).

5. The frying appliance described in claim 4 wherein:
the length and position of the rack (24) is configured in a manner allowing the 180-degree rotation of the frying unit.

6. The frying appliance described in claim 4 wherein:
there is another pin (22), coaxial with the pin (21), fixed to the lower frying plate (20) on the opposite side of the diameter of the lower frying plate (20).

7. The frying appliance described in claim 6 wherein:
the other pin (22) is located so as to extend into the U-shaped and preferably rectangular cross section swivel inhibitor hole (28) in a manner that it can rotate therein, where
the arms of the swivel inhibitor (28) are arranged so that they extend along and are guided by the opposite sides of the preferably rectangular cross section guiding column (29), fixed to the surface of the upper cover (3).

8. The frying appliance described in claim 7 wherein:
the lower reduced cross-section end of the guiding column (29) extends into the oil pan beyond the lower edge of the upper cover (3).

9. The frying appliance described in claim 1 wherein:
when ready for frying, the upper edge of the oil pan (10) is under the level of the upper edge of the lower cover (2).

10. The frying appliance described in claim 3 wherein:
there is a pin (21) fixed to the lower frying plate (20) extending into the hole going through and with an axis perpendicular to the vertical midline of the upper cover (3), on the surface of the support tube (15),
and a gear with a ratchet mechanism (23), is fixed on the pin (21) between the support tube (15) and the lower frying plate (20), and
the gear (23) is in a functional connection with the rack (24), fixed to the surface of the upper cover (3) and parallel with the component of the surface of the upper cover (3).

11. The frying appliance described in claim 10 wherein:
the length and position of the rack (24) is configured in a manner allowing the 180-degree rotation of the frying unit.

12. The frying appliance described in claim 11 wherein:
there is another pin (22), coaxial with the pin (21), fixed to the lower frying plate (20) on the opposite side of the diameter of the lower frying plate (20).

13. The frying appliance described in claim 12 wherein:
the other pin (22) is located so as to extend into the U-shaped and preferably rectangular cross section swivel inhibitor hole (28) in a manner that it can rotate therein, where
the arms of the swivel inhibitor (28) are arranged so that they extend along and are guided by the opposite sides of the preferably rectangular cross section guiding column (29), fixed to the surface of the upper cover (3).

14. The frying appliance described in claim 13 wherein:
the lower reduced cross-section end of the guiding column (29) extends into the oil pan beyond the lower edge of the upper cover (3).

15. The frying appliance described in claim 2 wherein:
when ready for frying, the upper edge of the oil pan (10) is under the level of the upper edge of the lower cover (2).

16. The frying appliance described in claim 3 wherein:
when ready for frying, the upper edge of the oil pan (10) is under the level of the upper edge of the lower cover (2).

17. The frying appliance described in claim 4 wherein:
when ready for frying, the upper edge of the oil pan (10) is under the level of the upper edge of the lower cover (2).

18. The frying appliance described in claim 5 wherein:
when ready for frying, the upper edge of the oil pan (10) is under the level of the upper edge of the lower cover (2).

19. The frying appliance described in claim 6 wherein:
when ready for frying, the upper edge of the oil pan (10) is under the level of the upper edge of the lower cover (2).

20. The frying appliance described in claim 7 wherein:
when ready for frying, the upper edge of the oil pan (10) is under the level of the upper edge of the lower cover (2).
